(19) United States
(12) Patent Application Publication
(10) Pub. No.: US 2011/0153898 A1
(43) Pub. Date: Jun. 23, 2011

(54) VEHICLES INCLUDING BUS-COUPLED HUB UNIT AND POWERTRAIN ELECTRONIC CONTROL UNIT AND METHOD

(76) Inventor: Brad L. Krempasky, II, Marysville, OH (US)

(21) Appl. No.: 12/644,601

(22) Filed: Dec. 22, 2009

(51) Int. Cl. G06F 13/36; G06F 7/00

(52) U.S. Cl. 710/306; 701/29

(57) ABSTRACT

A vehicle includes a body structure, a powertrain, a plurality of sensors, a hub unit, a plurality of leads, a powertrain electronic control unit, and a bus. The powertrain is supported by the body structure and includes an engine and a transmission. Each of the sensors is operable for detecting a respective parameter of the powertrain and for generating a corresponding sensor signal. The leads each couple a respective one of the sensors to the hub unit. The bus couples the hub unit to the powertrain electronic control unit. The hub unit is configured to receive the sensor signals from the sensors and, in response to the sensor signals, generate feedback signals and transmit the feedback signals over the bus to the powertrain electronic control unit. A method is also provided.

### TECHNICAL HELD

A vehicle includes a hub unit which receives sensor signals reflecting powertrain parameters and, in response, generates and transmits feedback signals over a bus to a powertrain electronic control unit.

### BACKGROUND

A powertrain electronic control unit is mounted to a body structure, such as a firewall, within an engine compartment of a conventional vehicle. Sensors mounted to an engine and transmission of a powertrain of the conventional vehicle are connected with leads to the powertrain electronic control unit. A bus couples the powertrain electronic control unit with additional electronic control units provided on the vehicle. The bus facilitates communication of binary messages among the powertrain electronic control unit and the additional electronic control units in a controller-area network.

### SUMMARY

In accordance with one embodiment, a vehicle comprises a body structure, a powertrain, a plurality of sensors, a hub unit, a plurality of leads, a powertrain electronic control unit, and a bus. The powertrain is supported by the body structure and comprises an engine and a transmission. Each of the sensors is operable for detecting a respective parameter of the powertrain and for generating a corresponding sensor signal. The leads each couple a respective one of the sensors to the hub unit. The bus unidirectionally couples the hub unit to the powertrain electronic control unit. The hub unit is configured to receive the sensor signals from the sensors and, in response to the sensor signals, generate feedback signals and transmit the feedback signals over the bus to the powertrain electronic control unit.

In accordance with another embodiment, a vehicle comprises a body structure, a powertrain, a plurality of sensors, a hub unit, a plurality of leads, a powertrain electronic control unit, and a bus. The powertrain is supported by the body structure and comprises an engine and a transmission. The sensors are mounted to the powertrain and are each operable for detecting a respective parameter of the powertrain and for generating a corresponding sensor signal. The hub unit is mounted to the powertrain. The leads each couple a respective one of the sensors to the hub unit. The powertrain electronic control unit is mounted to the body structure. The bus couples the hub unit to the powertrain electronic control unit. The hub unit is configured to receive the sensor signals from the sensors and, in response to the sensor signals, generate feedback signals and transmit the feedback signals over the bus to the powertrain electronic control unit in the form of binary messages.

In accordance with yet another embodiment, a method is provided for communicating signals on a vehicle. The vehicle comprises a powertrain supported by a body structure. The method comprises detecting parameters of the powertrain through use of sensors mounted to the powertrain. The method further comprises generating sensor signals corresponding to the detected parameters, and transmitting the sensor signals to a hub unit. The hub unit is mounted to the powertrain. The method additionally comprises generating feedback signals in response to the sensor signals, and transmitting the feedback signals in the form of binary messages over a bus to a powertrain electronic control unit mounted to the body structure.

### BRIEF DESCRIPTION OF THE DRAWINGS

While the specification concludes with claims particularly pointing out and distinctly claiming the present invention, it is believed that the same will be better understood from the following description taken in conjunction with the accompanying drawings in which:

FIG. 1 is a side perspective view depicting a vehicle in accordance with one embodiment, wherein a powertrain and a powertrain electronic control unit of the vehicle are illustrated in dashed lines;

FIG. 2 is a side perspective view depicting a portion of the powertrain of the vehicle of FIG. 1, wherein a hub unit is shown in solid lines to be attached to an engine of the powertrain, and an alternative hub unit is shown in dashed lines as being attached to a transmission of the powertrain;

FIG. 3 is an enlarged and partially exploded side perspective view depicting the hub unit and a portion of the engine of FIG. 2 in association with other components; and

FIG. 4 is a schematic diagram depicting various components of the vehicle of FIG. 1.

### DETAILED DESCRIPTION

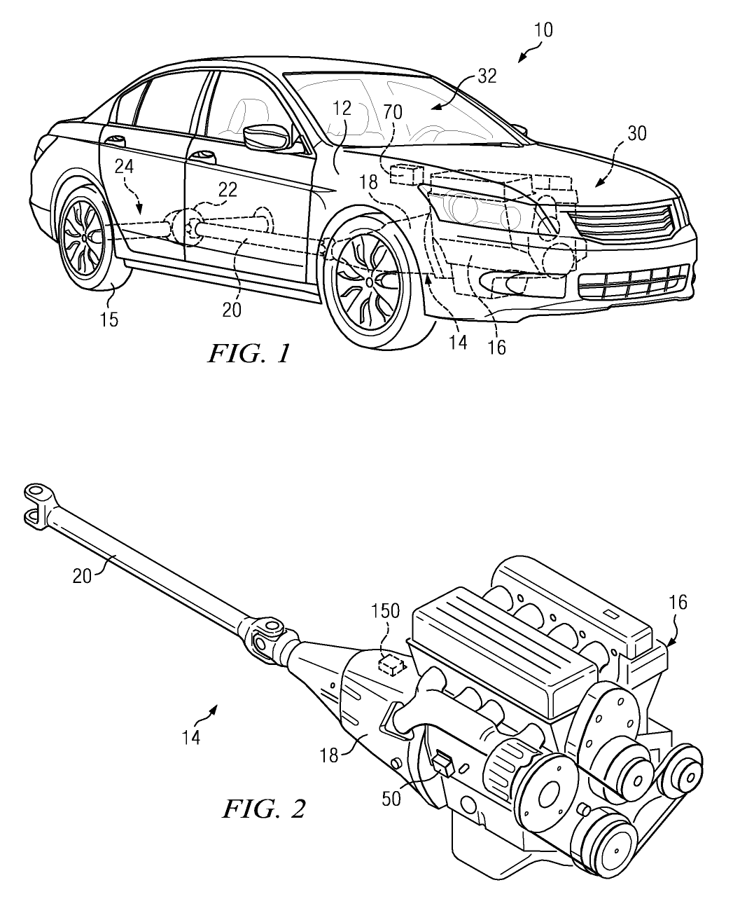

Certain embodiments are hereinafter described in detail in connection with the views and examples of FIGS. 1-4, wherein like numbers indicate the same or corresponding elements throughout the views. A vehicle 10 is shown in FIG. 1 to include a powertrain 14 supported by a body structure 12. The body structure 12 can comprise frame members, body members, and/or other components that generally define a shell of the vehicle 10. In one embodiment, the body structure 12 can comprise a unibody-type structure. In other embodiments, the body structure 12 can comprise multiple body panels welded to an underlying frame structure. The body structure 12 can define an engine compartment (shown as 30 in FIG. 1) which is configured to contain at least a portion of the powertrain 14 of the vehicle. The body structure 12 can also define a passenger compartment (shown as 32 in FIG. 1) which is configured to support and hold people and/or cargo during use of the vehicle 10. In one embodiment, the vehicle can comprise an automobile, an example of which is shown in FIG. 1. However, in other embodiments, the vehicle can comprise a truck, a bus, a van, a utility vehicle, a recreational vehicle, a watercraft, an aircraft, and/or any of a variety of other types of vehicles.

It will be appreciated that the powertrain 14 can be generally configured to provide motive power to one or more wheels (e.g., rear wheel 15) of the vehicle 10 to facilitate propulsion of the vehicle 10. The powertrain 14 is shown in FIGS. 1-2 to include an engine 16, a transmission 18, a driveshaft 20, and a rear axle assembly 24 having a differential 22. Though the engine 16 is shown to comprise an internal combustion engine which is configured for consuming fuels such as gasoline, diesel fuel, ethanol, kerosene, propane, hydrogen, and/or natural gas, it will be appreciated that a powertrain in accordance with alternative embodiments might additionally and/or alternatively include one or more electric motors to facilitate hybrid and/or fully electric propulsion of the vehicle. The powertrain 14 can be coupled with rear wheels (15, one shown in FIG. 1) of the vehicle 10 such that the vehicle 10 can be configured for rear-wheel drive operation, as in the example of FIG. 1. However, in alternative embodiments, a vehicle can be configured for front wheel operation and/or all wheel drive operation, for example. It will be appreciated that the transmission 18 of the powertrain 14 can be an automatic type of transmission or a manual type of transmission, and that a vehicle in accordance with still further embodiments might not include any transmission. It will accordingly be appreciated that a powertrain of a vehicle can be provided in any of a variety of suitable configurations or arrangements.

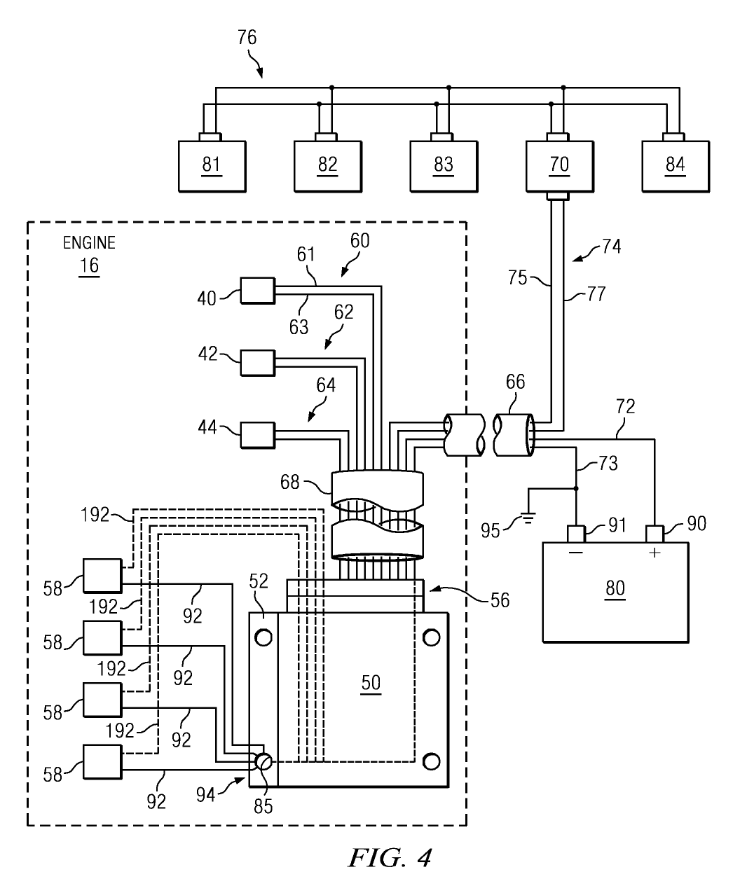

The vehicle 10 can also include a plurality of sensors which are mounted to the powertrain 14. The sensors can each be operable for detecting a respective parameter of the powertrain 14 and for generating a corresponding sensor signal. For example, as shown schematically in FIG. 4, sensors 40, 42 and 44 can be associated with the engine 16. One or more of the sensors 40, 42, and 44 can be configured for detecting powertrain parameters such as shift solenoid position, starter clutch position, countershaft speed, mainshaft speed, oil pressure, transmission line pressure, transmission fluid temperature, water temperature, air flow, throttle body position, manifold absolute pressure, oxygen, air/fuel ratio, ignition coil status, fuel injector status, cam position, intake manifold valve position, engine knock, and air conditioner clutch position. In one embodiment, the sensors 40, 42 and 44 can be mounted to corresponding portions of the engine 16 such as through use of interlocking mechanical features, threading, fasteners, or otherwise. In other embodiments, one or more sensors can be mounted to or otherwise associated with portions of the powertrain 14 other than the engine 16. While only three sensors 40, 42 and 44 are shown in FIG. 4 to be associated with the engine 16, it will be appreciated that fewer than three or more than three such sensors can be associated with an engine and/or powertrain, with the quantity and configuration of the sensors of a particular vehicle depending upon those parameters of the engine which are desired to be monitored.

Each of the sensors 40, 42 and 44 can be configured to generate sensor signals corresponding to parameters to be detected by the sensor. It will be appreciated that, by way of such sensor signals, a sensor can be configured to provide digital information or analog information, depending upon the intended role of the sensor upon the associated vehicle. For example, a sensor can provide digital information such as when reporting a parameter which has only two possible operational states such as, for example, when monitoring and reporting the position of a starter clutch as being engaged or disengaged. As another example, a sensor can provide analog information such as when reporting a parameter which has a large number or continuum of possible operational states such as, for example, when monitoring and reporting cam position. A sensor signal can convey analog information in an analog format (e.g., 0-10 V.D.C., 4-20 mA) or by way of a digitized message (e.g., using any of a variety of serial communication protocols). In one embodiment, at least one of the sensors 40, 42, and 44 can be configured to generate a corresponding one of the sensor signals in an analog format. By monitoring sensor signals from a particular one of the sensors 40, 42, or 44, the state of the detected parameter can be determined.

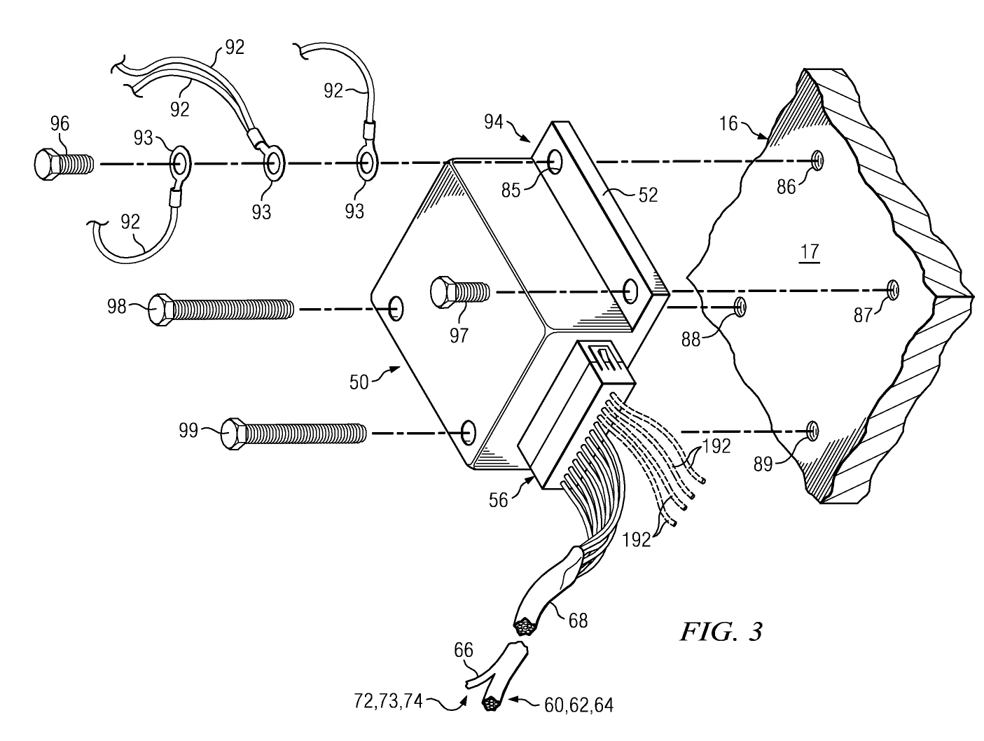

The vehicle 10 can further comprise a hub unit 50 which can be attached to the engine 16 as shown in FIGS. 2-4. In other embodiments, a hub unit can be attached to an alternative portion of a vehicle's powertrain. For example, an alternative hub unit 150 is shown in dashed lines in FIG. 2 to be attached to the transmission 18 of the powertrain 14. While the hub unit 50 is shown in FIG. 3 to be suitable for mounting or attachment to the engine 16 with bolts 96, 97, 98, and 99 inserted into respective threaded apertures 86, 87, 88, and 89 in a portion of the engine 16, it will be appreciated that a hub unit can be mounted to an engine or other portion of a vehicle's powertrain in any of a variety of other suitable configurations. In one alternative configuration, a hub unit can be mounted to an engine by attachment to a mounting bracket or other component, which in turn is mounted to the engine. It will be appreciated that, in one embodiment, conductive grease can be provided between the hub unit and the powertrain to facilitate effective heat transfer from the hub unit to the powertrain, and/or to facilitate minimal electrical resistance between a baseplate (52 in FIG. 3) of the hub unit and the powertrain (e.g., mounting surface 17 of the engine 16 as shown in FIG. 3).

The vehicle 10 can further comprise a plurality of leads which each couple a respective one of the sensors to the hub unit 50. In particular, with reference to FIG. 4, leads 60, 62, and 64 are shown to couple the respective sensors 40, 42 and 44 to the hub unit 50. In one embodiment, such as shown in the example of FIG. 4, a respective lead is provided for each respective sensor. However, in an alternative embodiment, a single lead can couple multiple respective sensors with a hub unit. In one embodiment, a lead (e.g., 60) can comprise a pair of wires, with the pair of wires including a lead signal wire (e.g., 61) and a lead signal ground wire (e.g., 63). In another embodiment, a lead can comprise only a single wire, namely a lead signal wire, with an associated sensor obtaining a signal ground by way of local grounding to a conductive portion of the powertrain at or near the sensor (e.g., a metal body of the sensor is threadably received within a metal aperture in the engine, thus obtaining signal ground from the engine). In still another embodiment, a lead might not comprise an electrical conductor, but might rather comprise a fiber optic coupling, fluid coupling (e.g., hydraulic, pneumatic, or vacuum), and/or mechanical coupling. The sensor signals from the respective sensors 40, 42 and 44 can be transmitted to the hub unit 50 by way of the sensor leads 60, 62 and 64.

The vehicle 10 can further comprise a powertrain electronic control unit 70 which can be mounted remotely from the powertrain 14. For example, with general reference to FIG. 1, the powertrain electronic control unit 70 can be mounted to the body structure 12 at a location within the engine compartment 30, but at a location remote from the powertrain 14. For example, in one embodiment, the powertrain electronic control unit can be mounted to a firewall or fender portion of the body structure 12.

A bus 74 can be provided to couple the hub unit 50 with the powertrain electronic control unit 70. In one embodiment, the bus 74 can unidirectionally couple the hub unit 50 to the powertrain electronic control unit 70. In such a configuration, the hub unit 50 can transmit feedback signals over the bus 74 to the powertrain electronic control unit 70, but the hub unit 50 and/or the powertrain control unit 70 can be configured such that they cannot facilitate transmission of signals over the bus 74 from the powertrain electronic control unit 70 to the hub unit 50. In an alternative embodiment, the bus 74 can bidirectionally couple the hub unit 50 to the powertrain electronic control unit 70. In such a configuration, the hub unit 50 can transmit feedback signals over the bus 74 to the powertrain electronic control unit 70, and the powertrain electronic control unit 70 can transmit signals over the bus 74 to the hub unit 50. It will be appreciated that, in some circumstances, a unidirectional coupling, as compared to bidirectional coupling, between the hub unit 50 and the powertrain electronic control unit 70, can result in more rapid and efficient transfer of feedback signals from the hub unit 50 to the powertrain electronic control unit 70.

In one embodiment, the bus 74 can comprise a pair of wires, with the pair of wires including a bus signal wire 75 and a bus signal ground wire 77. In another embodiment, the bus can comprise a different number of wires, or might alternatively comprise a fiber optic coupling, fluid coupling (e.g., hydraulic, pneumatic, or vacuum), and/or mechanical coupling. The hub unit 50 can be configured to receive the sensor signals from the sensors 40, 42 and 44. In response to the sensor signals, the hub unit 50 can generate feedback signals and transmit the feedback signals over the bus 74 to the powertrain electronic control unit 70. In one embodiment, the hub unit 50 can transmit the feedback signals over the bus 74 to the powertrain electronic control unit 70 in the form of binary messages. In another embodiment, the hub unit 50 can be further configured to transmit the binary messages over the bus 74 to the powertrain electronic control unit 70 in the form of controller-area network (“CAN”) messages. In such an embodiment, the hub unit 50 can be configured to translate the respective sensor signals from each sensor (e.g., 40, 42, 44) into CAN messages for transmission over the bus 74 to the powertrain electronic control unit 70. The hub unit 50 can include electronic components suitable to receive, process, prioritize, and transmit the CAN messages to the powertrain electronic control unit 70.

The vehicle 10 can include a second bus 76 which is coupled with the powertrain electronic control unit 70 and a plurality of additional electronic control units (e.g., 81, 82, 83, and 84) present upon the vehicle 10. The powertrain electronic control unit 70 and the additional electronic control units (e.g., 81, 82, 83, and 84) can be configured to transmit and receive binary messages over the second bus 76 to facilitate communication with one another. In one embodiment, these binary messages can take the form of CAN messages such that the powertrain electronic control unit 70 and the additional electronic control units (e.g., 81, 82, 83, and 84) can collectively form part of a CAN network. While the powertrain electronic control unit 70 can be generally configured to monitor and control operation of the powertrain 14 of the vehicle 10, it will be appreciated that the additional electronic control units can be respectively configured to control other respective systems on the vehicle 10 such as, for example, a climate control system, a navigation system, a suspension control system, a window control system, a door lock control system, and/or any of a variety of other systems present upon the vehicle.

The second bus 76 can accordingly facilitate communications among the respective electronic control units 70, 81, 82, 83, and 84 as needed or desirable during normal operation of the vehicle. By providing the bus 74 separate from the second bus 76, transmission of feedback signals from the hub unit 50 to the powertrain electronic control unit 70 can occur without resulting in delays to communications passing on the second bus 76 among the various electronic control units 70, 81, 82, 83 and 84. Also, by providing the bus 74 separate from the second bus 76, communications can pass on the second bus 76 among the various electronic control units 70, 81, 82, 83 and 84 without resulting in delays in transmission of feedback signals from the hub unit 50 to the powertrain electronic control unit 70. By mounting the hub unit 50 to the powertrain 14, the length of the leads from the respective powertrain-mounted sensors can be shorter than if they were routed directly to the powertrain electronic control unit 70, thereby saving in cost, weight, space, and installation time attributable to the leads.

The vehicle 10 can also include a battery 80 which can have positive and negative terminals 90, 91 coupled with the hub unit 50 though use of a power wire 72 and a ground wire 73, respectively. The negative terminal 91 of the battery 80 can also be coupled with the body structure 12 of the vehicle 10 (generally shown at 95 in FIG. 4) to create a negative chassis ground configuration. It will be appreciated that, in addition to the power wire 72 leading to the hub unit 50, additional power wires (not shown) can be also be coupled to the positive terminal 90 of the battery 80 such as for providing power to such devices as a starter solenoid, fusebox, and/or other electrical devices provided upon the vehicle 10. It will be appreciated that, in an alternative embodiment, as opposed to the negative chassis ground configuration described above, a vehicle can have the positive terminal of a battery coupled with the vehicle's body structure to create a positive chassis ground configuration, or can alternatively have neither battery terminal coupled with the vehicle's body structure to create a floating ground configuration.

In one embodiment, the power wire 72, the ground wire 73, and the bus 74 can be routed at least partially to the hub unit 50 through a common sheath or loom 66. However, it will be appreciated that a power wire, ground wire, and/or bus can be separately or otherwise routed to a hub unit in any of a variety of alternative configurations. The hub unit 50 is shown in FIGS. 3-4 to comprise a housing 54 attached to the baseplate 52, and to further include a connector 56 associated with the housing 54. In one embodiment, as shown in FIGS. 3-4, the leads 60, 62, 64 from the respective sensors 40, 42, 44, the power wire 72, the ground wire 73, and the bus 74 can all be coupled with the hub unit 50 by way of this single connector 56. However, it will be appreciated that, in an alternative embodiment, a hub unit might be provided with multiple connectors to facilitate separate coupling of one or more of the leads, wires, and bus to the hub unit. It will also be appreciated that a connector can be provided in any of a variety of suitable alternative arrangements or positions with respect to a housing of a hub unit. It will further be appreciated that a housing of a hub unit can have any of a variety of suitable shapes, sizes and configurations alternative to that depicted in FIG. 3 and can be mounted in any of a variety of suitable positions upon an engine or other portion of a vehicle's powertrain. In one embodiment, the leads 60, 62, 64, the power wire 72, the ground wire 73, and the bus 74 can be routed at least partially to the hub unit 50 through a common sheath or loom 68. However, it will be appreciated that the leads, power wire, ground wire, and/or bus can be separately or otherwise routed to a hub unit in any of a variety of alternative configurations.

In one embodiment, the baseplate 52 of the hub unit 50 can comprise a ground terminal 94, as generally shown in FIGS. 3-4. When the hub unit 50 is installed in the vehicle 10, the ground terminal 94 can be electrically coupled with the body structure 12, and through the body structure 12 can be electrically coupled with the negative terminal 91 of the battery 80. The ground terminal 94 can additionally or alternatively be electrically coupled with the negative terminal 91 of the battery 80 by way of the ground wire 73. In particular, the ground wire 73 can be electrically coupled with the ground terminal 94, and can accordingly comprise a ground bus for coupling the ground terminal 94 to the negative terminal 91 of the battery 80, and thus to the body structure 12.

Ground leads 92 can be coupled with the ground terminal 94 such as through use of ring terminals 93 and the bolt 96. It will be appreciated that, when the bolt 96 is inserted through the ring terminals 93, through an aperture 85 in the ground terminal 94, and into a threaded aperture 86 in the engine 16, the bolt 86 can perform a dual function of assisting in securing the hub unit 50 to the engine 16, and electrically coupling the ground leads 92 to the ground wire 73 and/or the body structure 12. In an alternative embodiment, a ground terminal of a hub unit might additionally or alternatively comprise a terminal block, a connector, and/or any of a variety of other suitable features. For example, in addition to or in lieu of the ground leads 92 which are shown to be coupled with the hub unit 50 through use of ring terminals 93 and the ground terminal 94, one or more ground leads (e.g., shown in dashed lines as 192 in FIGS. 3-4) can be coupled with the hub unit 50 by way of the connector 56 and can be electrically coupled with the negative terminal 91 of the battery 80 though the ground terminal 94 and/or the ground wire 73.

Each of the ground leads 92 and/or 192 can lead to respective electrical components (identified as 58 in FIG. 4) mounted to the engine 16 or other portion of the powertrain 14 such as, for example, fuel injectors, solenoids, motors, and/or other such devices. In such a configuration, each of the electrical components 58 can accordingly be grounded to a common location (i.e., the ground terminal 94), which in turn is directly coupled with the negative terminal 91 of the battery 80, thus providing an efficient, reliable, and low-resistance grounding arrangement for the electrical devices 58. It will be appreciated that, in such a configuration, in addition to serving as a hub for leads from sensors, the hub unit 50 can serve as a hub for ground leads. The length of the ground leads from the respective electrical components 58 can accordingly be shorter than if they were routed directly to the battery 80, thereby saving in cost, weight, space, and installation time attributable to the ground leads.

The foregoing description of embodiments and examples of the invention has been presented for purposes of illustration and description. It is not intended to be exhaustive or to limit the invention to the forms described. Numerous modifications are possible in light of the above teachings. Some of those modifications have been discussed and others will be understood by those skilled in the art. The embodiments were chosen and described in order to best illustrate the principles of the invention and various embodiments as are suited to the particular use contemplated. The scope of the invention is, of course, not limited to the examples or embodiments set forth herein, but can be employed in any number of applications and equivalent devices by those of ordinary skill in the art. Rather it is hereby intended the scope of the invention be defined by the claims appended hereto.

What is claimed is:

1. A vehicle comprising:
a body structure;
a powertrain supported by the body structure and comprising an engine and a transmission;
a plurality of sensors, each of the sensors operable for detecting a respective parameter of the powertrain and for generating a corresponding sensor signal;
a hub unit;
a plurality of leads each coupling a respective one of said sensors to the hub unit;
a powertrain electronic control unit; and
a bus unidirectionally coupling the hub unit to the powertrain electronic control unit;
wherein the hub unit is configured to receive the sensor signals from said sensors and, in response to the sensor signals, generate feedback signals and transmit the feedback signals over the bus to the powertrain electronic control unit.

2. The vehicle of claim 1 wherein at least one of said leads comprises a pair of wires, the pair of wires comprising a lead signal wire and a lead signal ground wire.

3. The vehicle of claim 1 wherein the bus comprises a pair of wires, the pair of wires comprising a bus signal wire and a bus signal ground wire.

4. The vehicle of claim 1 wherein the powertrain electronic control unit is mounted to the body structure, the hub unit is mounted to the powertrain, and at least some of said sensors are mounted to the powertrain.

5. The vehicle of claim 4 wherein the hub unit is mounted to the engine, and wherein the at least some of said sensors are mounted to the engine and are each operable for detecting a respective parameter of the engine.

6. The vehicle of claim 4 wherein the hub unit is further configured to transmit the feedback signals over the bus to the powertrain electronic control unit in the form of binary messages.

7. The vehicle of claim 6 wherein the hub unit is further configured to transmit the binary messages over the bus to the powertrain electronic control unit in the form of controller-area network messages.

8. The vehicle of claim 1 further comprising a second bus and a plurality of additional electronic control units, wherein the second bus is coupled with the powertrain electronic control unit and each of the plurality of additional electronic control units, and wherein the powertrain electronic control unit and the additional electronic control units are configured to transmit and receive binary messages over the second bus to facilitate communication with one another.

9. The vehicle of claim 8 wherein the powertrain electronic control unit and the additional electronic control units are configured to transmit and receive the binary messages over the second bus in the form of controller-area network messages.

10. The vehicle of claim 1 further comprising a ground bus, wherein the hub unit comprises a ground terminal coupled with the ground bus, the ground terminal is configured to receive a plurality of ground leads from a plurality of respective engine-mounted electrical components, and the ground bus is configured to facilitate coupling of the ground terminal with the body structure.

11. The vehicle of claim 1 wherein at least one of said sensors is configured to generate a corresponding one of the sensor signals in an analog format.

12. The vehicle of claim 1 wherein the hub unit is further configured to transmit the feedback signals over the bus to the powertrain electronic control unit in the form of binary messages.

13. The vehicle of claim 6 wherein the hub unit is further configured to transmit the binary messages over the bus to the powertrain electronic control unit in the form of controller-area network messages.

14. A vehicle comprising:
a body structure;
a powertrain supported by the body structure and comprising an engine and a transmission;
a plurality of sensors mounted to the powertrain, each of the sensors operable for detecting a respective parameter of the powertrain and for generating a corresponding sensor signal;
a hub unit mounted to the powertrain;
a plurality of leads each coupling a respective one of said sensors to the hub unit;
a powertrain electronic control unit mounted to the body structure; and
a bus coupling the hub unit to the powertrain electronic control unit;
wherein the hub unit is configured to receive the sensor signals from said sensors and, in response to the sensor signals, generate feedback signals and transmit the feedback signals over the bus to the powertrain electronic control unit in the form of binary messages.

15. The vehicle of claim 14 wherein:
at least one of said sensors is configured to generate a corresponding one of the sensor signals in an analog format;
at least one of said leads comprises a lead signal wire and a lead signal ground wire; and
the bus comprises a bus signal wire and a bus signal ground wire.

16. The vehicle of claim 14 wherein the hub unit is mounted to the engine, and wherein at least some of said sensors are mounted to the engine and are each operable for detecting a respective parameter of the engine.

17. The vehicle of claim 14 further comprising a second bus and a plurality of additional electronic control units, wherein:
the second bus is coupled with the powertrain electronic control unit and each of the plurality of additional electronic control units; and
the powertrain electronic control unit and the additional electronic control units are configured to transmit and receive binary messages over the second bus to facilitate communication with one another.

18. The vehicle of claim 17 wherein:
the hub unit is further configured to transmit the binary messages over the bus to the powertrain electronic control unit in the form of controller-area network messages; and
the powertrain electronic control unit and the additional electronic control units are configured to transmit and receive the binary messages over the second bus in the form of controller-area network messages.

19. The vehicle of claim 14 further comprising a ground bus, wherein the hub unit comprises a ground terminal coupled with the ground bus, the ground terminal is configured to receive a plurality of ground leads from a plurality of respective engine-mounted electrical components, and the ground bus is configured to facilitate coupling of the ground terminal with the body structure.

20. The vehicle of claim 14 wherein the bus unidirectionally couples the hub unit to the powertrain electronic control unit.

21. A method for communicating signals on a vehicle, the vehicle comprising a powertrain supported by a body structure, the method comprising:
detecting parameters of the powertrain through use of sensors mounted to the powertrain;
generating sensor signals corresponding to the detected parameters;
transmitting the sensor signals to a hub unit, the hub unit being mounted to the powertrain;
generating feedback signals in response to the sensor signals; and
transmitting the feedback signals in the form of binary messages over a bus to a powertrain electronic control unit mounted to the body structure.
